(19) United States
(12) Patent Application Publication
(10) Pub. No.: US 2021/0301472 A1
(43) Pub. Date: Sep. 30, 2021

(54) DIAMOND ENRICHED INSULATION PAPER FOR THE COOLING IMPROVEMENT OF AN ELECTRICAL MACHINE

(71) Applicants: Zlatko KOLONDJOVSKI, Helsinki (FI); Aron Szucs, Helsinki (FI); Jan Westerlund, Helsinki (FI)

(72) Inventors: Zlatko KOLONDJOVSKI, Helsinki (FI); Aron Szucs, Helsinki (FI); Jan Westerlund, Helsinki (FI)

(21) Appl. No.: 17/250,444

(22) PCT Filed: Jul. 24, 2019
(86) PCT No.: PCT/FI2019/050558

§ 371 Date: Jan. 22, 2021

(30) Foreign Application Priority Data
Jul. 24, 2018 (LU) LU100876

(51) Int. Cl. D21H 17/67; D21H 27/00; D21H 21/52; D21H 13/26; H01B 3/52

(52) U.S. Cl. CPC D21H 17/67; D21H 27/00; H01B 3/52; D21H 13/26; D21H 21/52

(57) ABSTRACT

The thermal conductivity of the electrical paper insulation could be increased if the paper material is either enriched or fully substituted by a material with higher thermal conductivity. Diamond as enrichment material will be the right choice because besides the high thermal conductivity, it also acts as an excellent electrical insulator and has good mechanical properties. The thermal conductivity of the diamond is k_{diamond}=2200 [W/mK], that is even more than 7000 times higher than the paper material. Diamond enriched insulation papers have not existed before this invention. In the proposed structure the diamond particles are held in place also by the fibrous substance of the paper itself, without the need of a holding matrix material by default, as shown in FIG. 1. The diamond particles mixed in the paper can also penetrate the paper across creating a thermal bridge between the insulated parts while maintaining strong electrical insulation.

### 1. INTRODUCTION

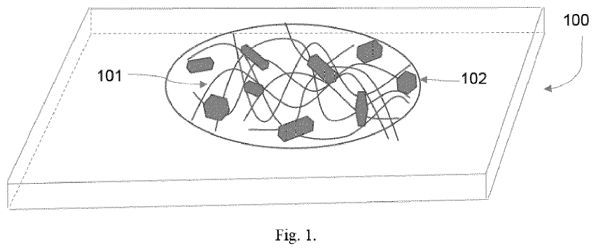

In a steady-state performance of a salient-pole synchronous machine, the hottest part in the rotor is usually the rotor winding. Any kind of improvement of the cooling effectiveness of the rotor winding contributes to its longer lifespan and increased power/cost ratio in its design and manufacturing. The idea of this invention is to improve the cooling ability of the both wound-type and flat-copper rotor windings by the use of a diamond-based insulation by replacing the paper and polyester-laminate insulation materials that have the main role of electrical insulators. Both of the rotor constructions considered here are represented in FIG. 1. As we can see from FIG. 1.a), the wound type rotor winding is insulated using paper insulation from the aluminium support, the pole shoe and the pole arm (not visible in the FIGURE). The most efficient cooling due to convection takes place in the region between the poles enhanced by the aluminium support that has a finned surface. Unfortunately, the heat generated inside the rotor winding approaches that region across the paper sheet placed between the winding and the aluminium support. This paper sheet, although thin, represents a significant thermal barrier because of its very low thermal conductivity. The pole arm and shoe are rotor parts that are usually cooler than the rotor winding and can contribute to its cooling, but in order to reach them, the heat should be also transferred across the insulating papers sheets. The flat-copper rotor winding presented in FIG. 1.b) uses paper insulation between the copper plates. The low thermal conductivity of the paper material has two negative effects regarding to cooling. It lowers the overall thermal conductivity of the rotor winding in radial direction and, because the paper sheets extend somewhat outside of the contact area, they cover a significant part of the outer (convective) cooling area. The pole arm is also insulated from the winding with a paper layer, and the top and the bottom of the winding are mechanically restrained with polyester laminates that also act as additional thermal insulators.

Insulation paper is also applied in the stator slot of electrical machines as ground wall insulation.

### 2. ANALYSIS OF THE CURRENT STATE

The analysis is performed on a salient-pole synchronous machine with wound-type rotor winding with nominal power of Pₙ=15 MW and voltage Vₙ=11 kV. At a nominal steady state condition, the measured average temperature of the rotor winding is tₘₑₐₛ=88.8° C. The same operational point is simulated using the thermal-network method and the calculated average temperature is t_{calc}=93.8° C. The paper sheet between the winding and the aluminium support has thickness of 0.5 mm and all other aforementioned paper layers are 0.72 mm thick. The presumed value of the thermal conductivity of the paper material is kₚₐₚₑᵣ=0.3 [W/m·K]. Just for comparison, the thermal conductivity of the aluminium is k_{Al}=215 [W/m·K], and of the winding k_{w_across}=2.8 [W/m·K] across the conductors and k_{w_along}=333 [W/m·K] along the conductors. The rotor core has thermal conductivity of k_{rc_rad}=30 [W/m·K] in radial direction and k_{rc_ax}=8 [W/m·K] in axial direction. It is obvious that the paper insulation has tens to hundreds of times lower thermal conductivity than all other materials, and an increase of its value can greatly improve the cooling of the rotor.

### 3. DESCRIPTION OF THE INVENTION

The thermal conductivity of the paper insulation could be increased if the paper material is either enriched or fully substituted by a material with higher thermal conductivity. A diamond material will be the right choice because besides the high thermal conductivity, it also acts as an excellent electrical insulator and has good mechanical properties. The thermal conductivity of the diamond is k_{diamond}=2200 [W/mK], that is even more than 7000 times higher than the paper material. We can conclude that if the paper insulation layer contains a certain amount of diamond-based material, its thermal conductivity will be significantly increased. In order to examine its positive effect on the cooling of the rotor winding, we can gradually increase the thermal conductivity of the paper material up to the value of a pure diamond, and for each value, the average temperature of the rotor winding is calculated. The calculations of the temperatures are summarized in Table. 1. The first row in Table 1 contains the original value of the thermal conductivity and the calculated average temperature of the rotor. After that, all the calculations are repeated for 2, 5, 10, 100 times increased thermal conductivity, and the last calculation is for using a pure diamond material instead of paper material. We can notice that by increasing the thermal conductivity of the paper insulation layer the average temperature of the rotor is significantly reduced, with maximum reduction of 6.8K if a pure diamond is used. However, the largest benefit is achieved when the thermal conductivity is increased only few times. If the thermal conductivity approaches the value of a pure diamond, the benefit is not any more emphasized that much because the overall thermal conduction is limited by the other materials. This conclusion eliminates the need of using pure diamond material if it does not represent a cost-effective solution.

TABLE 1
Thermal conductivities and calculated temperatures

| | kₚₐₚₑᵣ[W/m · K] | t_{calc} [° C.] |
|---|---|---|
| Original insulation | 0.3 | 93.8 |
| 2 times increased | 0.6 | 90.4 |
| 5 times increased | 1.5 | 88.4 |
| 10 times increased | 3.0 | 87.7 |
| 100 times increased | 30.0 | 87.1 |
| Pure diamond | 2200.0 | 87.0 |

### 4. PRIOR ART CONSIDERATIONS

We have not seen any limiting prior art for diamond enriched paper before this application. This means that both flake shaped diamond particles (significantly larger dimensions parallel with the paper surface) and diamond powder with any size—including diamond nanoparticles—of any shape could be applied in the diamond enriched paper patent. The most likely best solution would be to use “large” flake shaped diamond particles, parallel with the surface of the paper mixed into its material and also to use small micro and nano-diamond powder as filling material in the paper-diamond material mixture.

A special case could be a mixture of “large”—bigger than the width of the paper—diamond particles mixed into the paper which would penetrate through the paper surface on both of its sides creating tiny thermal bridges (thermal short circuit) and electrical separators between the copper on one side and the pole shoe on the other. Such thermal bridge creating “rough diamond” paper would require special manufacturing instructions to avoid unnecessary damage to the winding insulation, but it could provide extreme cooling abilities for the rotor winding and/or stator slot wall insulation.

### Novelty:

Diamond enriched insulation papers have not existed before this invention. In the proposed structure the diamond particles are held in place by the fibrous substance of the paper itself, without the need of a holding matrix material by default.

### Innovative Step:

Insulation papers for example those consisting of Nomex material have an important high thermal insulation property which is utilized in many applications. In electrical machines the thermal insulation is a disadvantage. Mixing diamond the best solid thermal conductor material into a paper made of thermally insulating fibrous insulation material like Nomex is an unprecedented innovative solution because while it destroys an important property of the insulator, the excellent thermal insulation it benefits the electrical insulation application. Also, contrary to prior art, the diamond particles are maintained in the paper without the need of a solid holding matrix material, as the paper consisting of fibrous substance can hold the diamond particles in place. The addition of any “glue” is not required for the whole volume just a part of it in order to maintain the flexibility of the paper while increasing somewhat the cohesion. When the paper is attached to another carrier, the “gluing” to that surface would also increase the cohesion of the paper.

### REFERENCE NUMERALS

100 Diamond enriched paper sheet
101 Fibrous substance, pulp of wood or other, including insulation materials such as Nomex.
102 Diamond particles

1. A paper material manufactured in thin felted sheets (100), from the pulp of wood or other fibrous substance (101) where the particles creating the sheets are mixed with diamond particles (102).

2. A paper material according to claim 1, where the paper particles and fibrous substance is made of electrical insulation material such as Nomex.

3. A paper material according to any of the preceding claims, where the paper particles are mixed with diamond particles which are in the shape of flakes where the dimensions of the diamond particles are at least ten times higher parallel to the paper surface versus the direction along the thickness of the paper to better restrict electron flow across the paper.

4. A paper material according to any of the preceding claims, where the diamond enriched paper mix has a gluing component added to it also to provide better cohesion of the paper particles, where the volume of the gluing component would be 1% to 50% of volume or more typically 5% to 20% of volume.

5. A paper material according to any of the preceding claims, where the diamond particles have their size between 1 micro meter to 1000 micro meter, or more typically between 20 to 300 micro meters to any given direction.

6. A paper material according to any of the preceding claims, where the density of diamond particles is from 1% to 40% of volume.

7. A paper material according to any of the preceding claims, where the diamond content is 70%-99.9% of volume of the paper sheet.

8. A paper material according to any of the preceding claims, where the diamond particles measured along their longest extensions are positioned substantially perpendicularly to the paper surface inside the sheets during manufacturing.

9. A paper material according to any of the preceding claims, where the diamond particles have rod shapes in which one dimension is at least ten times larger than the other two dimensions.

10. A paper material according to any of the preceding claims, where the paper is used as an insulator and is attached to another carrier surface like a polyester film or another non-conductive carrier.

11. A paper material according to any of the preceding claims, where the diamond particles have a larger dimension than the thickness of the paper and are allowed to penetrate through the paper layer.

12. A paper material according to any of the preceding claims, where the diamond particles have larger dimensions than the thickness of the paper, so the diamonds can penetrate across the paper.

13. A paper material according to any of the preceding claims, where the diamond particles have larger dimensions than the thickness of the paper and an additional carrier surface, so the diamonds can penetrate across the paper and the additional carrier surface also.
